(19) United States
(12) Patent Application Publication
(10) Pub. No.: US 2017/0092164 A1
(43) Pub. Date: Mar. 30, 2017

(54) MAILBOX FLAG COVER

(71) Applicant: Michael Abt, Vera Beach, FL (US)

(72) Inventor: Michael Abt, Vera Beach, FL (US)

(21) Appl. No.: 14/870,166

(22) Filed: Sep. 30, 2015

(51) Int. Cl. G09F 17/00; A47G 29/122

(52) U.S. Cl. CPC G09F 17/00; A47G 29/121; G09F 2017/0033

(57) ABSTRACT

A mailbox flag cover includes a weather resistant main body having at least one indicia element imprinted along the front facing surface. The back surface is coated with an adhesive material, and the main body is sized to cover a mailbox flag. The flag cover can also include a second indicia that is positioned opposite to the first indicia, and a weather strip that is located between the indicia elements.

### TECHNICAL FIELD

The present invention relates generally to decorative elements, and more particularly to a decorative cover for a mailbox flag.

### BACKGROUND

The statements in this section merely provide background information related to the present disclosure and may not constitute prior art.

Virtually every home, apartment, condo and/or business location in the United States has a mailbox that is used for sending and receiving mail through the U.S. Postal Service (USPS). In this regard, many such mailboxes include a utilitarian shape having an elongated pedestal with a storage compartment and a flag suspended therefrom. To this end, the purely functional shape of most mailboxes prevents individuals from imparting their own decorative elements onto the same without changing the physical components of the device.

Although there are many known decorative mailbox products, such as an open mouth fish, for example, which can replace the factory storage compartment of a USPS approved mailbox, these have been met with limited commercial success. This is because many of these devices are expensive to manufacture, difficult to install, and often do not fully conform to all of the requirements imposed by the U.S. Postal Service. Moreover, many homeowner associations stipulate a particular brand and/or style of mailbox that must be used for all homes within a community. As such, utilization of these replacement devices is prohibited within these communities.

Accordingly, it would be beneficial to provide a decorative mailbox flag cover that is inexpensive to manufacturer, easy to install, and that does not suffer from the drawbacks of the above noted devices.

### SUMMARY OF THE INVENTION

The present invention is directed to a mailbox flag cover device. One embodiment of the invention can include a weather resistant main body having at least one indicia element imprinted along the front facing surface. The device can include a shape and size that is complementary to the shape and size of a mailbox flag, and can further include an adhesive backing that allows the main body to be affixed onto the mailbox flag.

In another embodiment, the device can also include two distinct indicia elements that are reverse oriented, so as to cover the front and rear facing portions of a mailbox flag. When installed, the indicia will each be positioned upright so as to be visible along both sides of the mailbox when the flag is extended.

In yet another embodiment, the device can include a reinforced weather strip that is located between the indicia elements, and can function to prolong the useful life of the device.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a front view of a mailbox flag cover that is useful for understanding the inventive concepts disclosed herein.

FIG. 2 is a front view of the mailbox flag cover, in accordance with one embodiment of the invention.

FIG. 3A is a side view of the mailbox flag cover in operation, in accordance with one embodiment of the invention.

FIG. 3B is another side view of the mailbox flag cover in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

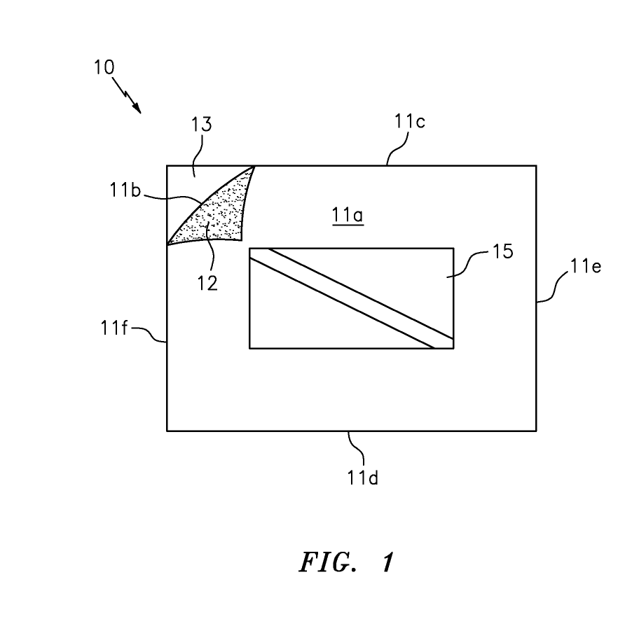

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

FIGS. 1-3 illustrate various embodiments of a decorative mailbox flag cover 10 that is useful for understanding the inventive concepts disclosed herein. As shown, the device 10 can include, essentially, a main body having a peel and stick backing, and various forms of indicia.

The main body 11 can function to cover the flag portion of a standard mailbox with any type of indicia that is selected by a user. To this end, the main body can include a top surface 11a, a bottom surface 11b, a top end 11c, a bottom end 11d, and a pair of opposing sides 11e and 11f. As the main body is designed to be adhered to an existing mailbox flag in a peel-and-stick manner, an adhesive material 12 can be disposed along an entirety of the bottom surface 11b, and the same can be covered by a removable covering layer 13.

The main body 11 can preferably include a generally rectangular shape, and can be constructed from any number of different materials that are suitable for prolonged exposure to the sun and weather conditions. To this end, one embodiment of the main body can be constructed from a sheet of ultraviolet resistant vinyl, for example, that is pre-printed with indicia at the time of manufacture.

In another embodiment, the main body 11 can be constructed from a single sheet of synthetic soft polyester paper which is known to include waterproof and static resistant features. Moreover, as synthetic paper is compatible with commercially available laser and ink jet printers, such a feature can allow the end user to print their own indicia onto the main body 11. Although described above with respect to particular shapes and materials, this is for illustrative purposes only, as any number of other shapes and materials are also contemplated.

Although dimensions are not critical, in the preferred embodiment, the main body 11 can include a length (e.g., distance between the top end 11c and bottom end 11d) of approximately 3.5 inches, and a width (e.g., distance between the opposing sides 11e and 11f) of approximately 2.75 inches. Such dimensions being suitable for covering the front and back facing portions of the upper flag portion of a standard USPS approved mailbox flag having a dimension of 2.75 inches×1.75 inches. Of course, other embodiments of the device are also contemplated wherein the main body is constructed from any number of other shapes, sizes and/or materials.

As described herein, the term “indicia” 15 can include any type of decorative elements such as colors, markings, words, shapes, symbols, logos, designs, lights, types of materials, texturing of materials, patterns, images, lithographs, photographs and/or drawings, for example. The indicia can be secured onto and/or into the main body 11 in accordance with known techniques so as to be flush with the surface of the main body or can be raised/protruding outward from the main body so as to give a three dimensional effect.

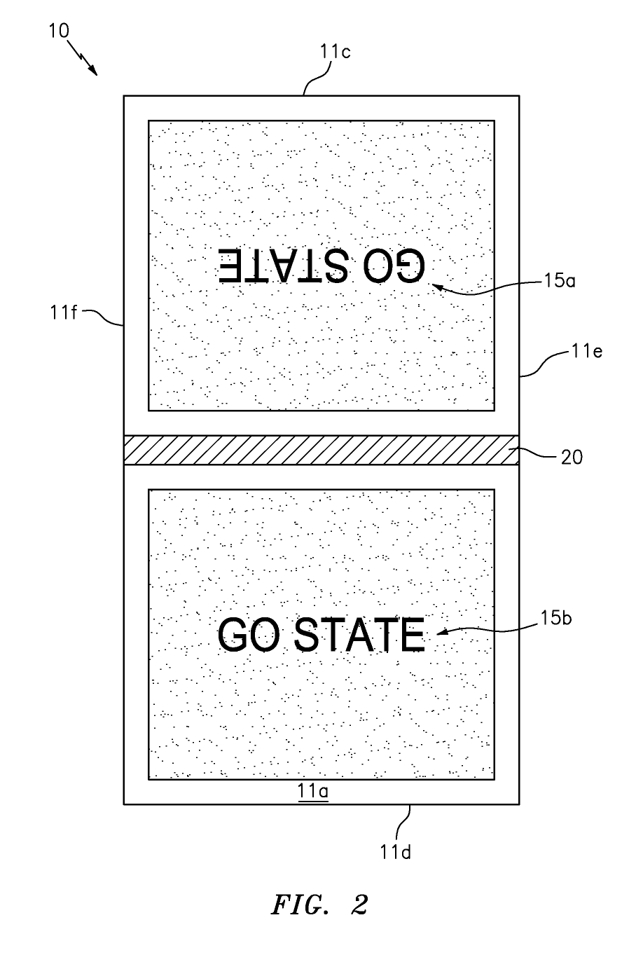

FIG. 2 illustrates another embodiment of the device 10, wherein the top surface of the main body 11a can include two distinct indicia elements 15a and 15b that are positioned at generally opposite orientations to each other. In this regard, when the main body is secured onto the mailbox flag, as described below, both images can appear right side up/upright. Of course, other embodiments are also contemplated wherein a single indicia element is disposed along an entirety of the main body 11.

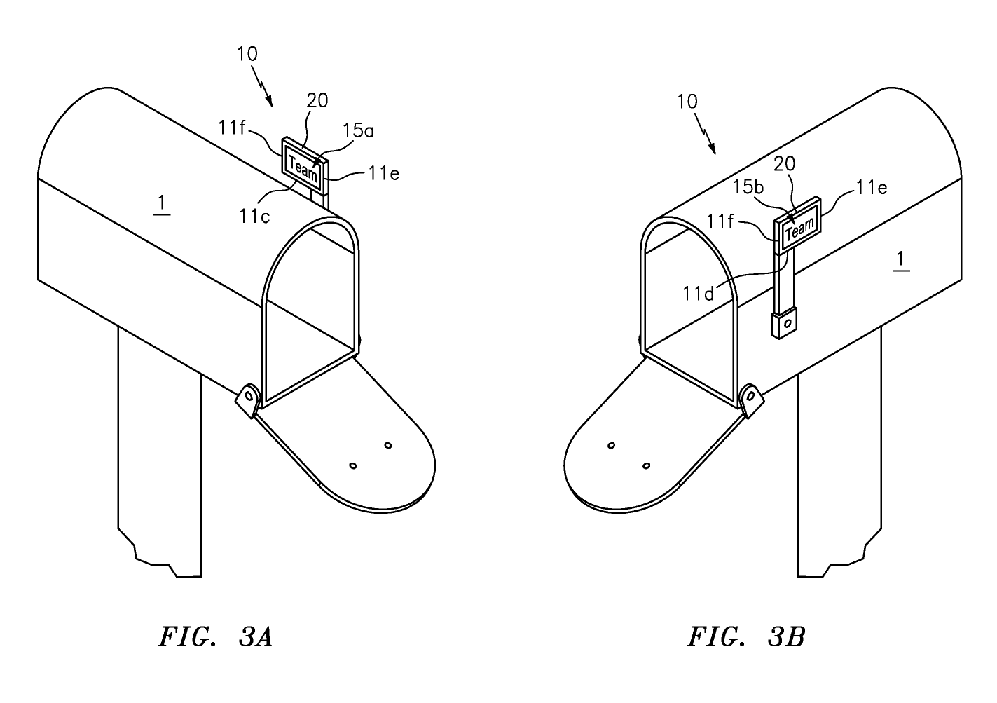

As shown, the main body can further include a weather strip 20 which can be disposed along the center of the main body and can extend between the opposing sides 11e and 11f. In the preferred embodiment, the weather strip 20 can include a piece of reinforced UV resistant tape, or other such material which can function to prevent the device 10 from deteriorating over time. In this embodiment, the location of the weather strip is designed to be located along the uppermost surface of the mailbox flag 2, so as to face the sun directly when the flag is deployed (i.e., in the upward extended position shown in FIG. 3A). Of course, any number of other materials are also contemplated.

FIGS. 3A and 3B illustrate one embodiment of the device 10 in operation. As shown, the device can be secured along the front and back sides of the flag portion 2 of a standard mailbox 1. When so positioned, the indicia 15a and 15b can be visible at all times, and from either side of the mailbox 1, so as convey the likes and interests of the mailbox owner.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A mailbox flag cover device, said device comprising:
a singular main body material having a front surface, a back surface, a top end, a bottom end, and a pair of opposing sides;
an adhesive material and removable covering layer that are disposed along the back surface, said adhesive material being configured to adhere the main body onto a mailbox flag in a peel and stick manner; and
at least one indicia element that is disposed along the top surface of the main body,
wherein the main body is constructed from an ultraviolet and weather resistant material that is suitable for prolonged exposure to outside elements.

2. The device of claim 1, wherein the main body is constructed from vinyl, and the at least one indicia is imprinted thereon at a time of construction.

3. The device of claim 1, wherein the main body is constructed from a single sheet of printer ready synthetic polyester paper.

4. The device of claim 1, wherein the main body includes a length and width that is complementary to a length and width of a front portion of the mailbox flag.

5. The device of claim 1, wherein the main body includes a dimension that consists of:
a length of approximately 3.5 inches, and a width of approximately 2.75 inches, said dimension
being configured to cover a front portion and a rear portion of the mailbox flag.

6. The device of claim 1, wherein the at least one indicia includes a first distinct indicia element and a second distinct indicia element.

7. The device of claim 6, wherein the first distinct indicia element is disposed at an opposite orientation to the second distinct indicia element, and
wherein each of the first and second distinct indicia elements are configured to be positioned upright when the mailbox flag is in the extended position.

8. The device of claim 7, further comprising:
a weather strip that is disposed along a center portion of the main body between the opposing sides.

9. The device of claim 8, wherein the weather strip is positioned between the first and second distinct indicia elements.

10. The device of claim 9, wherein the weather strip is constructed from a piece of reinforced UV resistant tape.
